(19) United States
(12) Patent Application Publication
(10) Pub. No.: US 2024/0265323 A1
(43) Pub. Date: Aug. 8, 2024

(54) SYSTEMS AND METHODS FOR MANAGING A FLEET OF PERSONAL MOBILITY CARTS

(71) Applicant: Amigo Mobility International, Inc., Bridgeport, MI (US)

(72) Inventors: Allan THIEME, Bridgeport, MI (US); Jeffrey BAKER, Bridgeport, MI (US)

(73) Assignee: Amigo Mobility International, Inc., Bridgeport, MI (US)

(21) Appl. No.: 18/429,847

(22) Filed: Feb. 1, 2024

Related U.S. Application Data
(60) Provisional application No. 63/443,175, filed on Feb. 3, 2023.

(51) Int. Cl. G06Q 10/0631; A61G 5/10; G06Q 50/43

(52) U.S. Cl. CPC G06Q 10/06315; A61G 5/10; G06Q 50/43

(57) ABSTRACT

A computer implemented method for determining locations of personal mobility carts in a fleet of personal mobility carts is provided. At least a first zone having a first perimeter boundary is established at a computing device having one or more processors. Geolocations of each personal mobility cart in the fleet of personal mobility carts are received at the computing device. The geolocations of each personal mobility cart of the fleet of personal mobility carts are compared with the first zone by the computing device. A determination is made by the computing device whether a personal mobility cart of the fleet of personal mobility carts occupies a location outside of the first zone. A notification is generated based on the determination by the computing device. A method for managing cart usage and battery usage of the fleet of carts is also provided.

### CROSS-REFERENCE TO RELATED APPLICATIONS

This application claims the benefit of U.S. Provisional Application No. 63/443,175 filed Feb. 3, 2023. The disclosure of the above application is incorporated herein by reference.

### FIELD

The present disclosure relates generally to systems and methods for managing a fleet of personal mobility carts.

### BACKGROUND

Personal mobility carts have been used to assist a rider in moving around a home, a building or outdoors. Most personal mobility carts are powered ride-on vehicles having a frame that supports a seat, and handlebars for controlling steering and acceleration. These personal mobility carts are typically propelled by an electric motor that is powered by a rechargeable on-board battery or collection of batteries. In some implementations, retail establishments such as stores can provide multiple personal mobility carts (such as a fleet) to be available for use by multiple customers within the store for transporting the rider during shopping and around the store's parking lot to shuttle the rider between the store and their ground transportation. As can be appreciated, it can be challenging to monitor real-time operational characteristics of each mobility cart in the fleet. Without a proper understanding of a mobility cart's status it is difficult to know when and if a cart is in need of maintenance such as a charge. Further, it is difficult to assess the location of each of the carts. A need exists for improved systems and methods for monitoring and reacting to real-time attributes of each mobility cart such as, but not limited to, state of charge, charging status, daily run time, total run time and geographic location.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer implemented method for determining locations of personal mobility carts in a fleet of personal mobility carts is provided. At least a first zone having a first perimeter boundary is established at a computing device having one or more processors. Geolocations of each personal mobility cart in the fleet of personal mobility carts are received at the computing device. The geolocations of each personal mobility cart of the fleet of personal mobility carts are compared with the first zone by the computing device. A determination is made by the computing device whether a personal mobility cart of the fleet of personal mobility carts occupies a location outside of the first zone. A notification is generated based on the determination by the computing device.

In other features, the method includes establishing, at the computing device, a second zone having a second perimeter boundary, the second zone having a different perimeter as compared to the first zone. The method includes determining, by the computing device, whether a personal mobility cart of the fleet of personal mobility carts transitions between the first zone and the second zone. Generating the notification can include identifying on the computing device the transition.

According to additional features, geolocations of each personal mobility cart in the fleet of personal mobility carts are displayed in real-time on a display of the computing device.

In other features, a push notification including an alarm indicative of the personal mobility cart occupying a geolocation outside of the first zone is generated at the computing device.

According to additional features, a signal is communicated to the personal mobility cart indicative of an unacceptable location of the personal mobility cart based on a determination that the geolocation of the personal mobility cart is outside of the first zone.

In other features, the signal can include at least one of a visual and audible alarm.

A computer implemented method for allocating fleets of personal mobility carts between a first store and a second store is provided. The method includes receiving, at a computing device having one or more processors, usage data from each personal mobility cart of a first fleet of personal mobility carts at a first store and each personal mobility cart of a second fleet of personal mobility carts at a second store. The first usage data of the first fleet and the second usage data of the second fleet are categorized at the computing device. The first usage data and the second usage data are compared at the computing device. A determination is made at the computing device based on the comparing whether one of the first and second fleet is overutilized as compared to the other of the first and second fleet. A recommendation is made at the computing device including a reallocation of at least one personal mobility cart from the other of the first and second fleet to the overutilized fleet.

According to additional features, the first usage data of the first fleet includes at least one of daily usage data and hourly usage data for the first store. The second usage data of the second fleet include at least one of daily usage data and hourly usage data for the second store.

In other configurations, the method includes determining, at the computing device, whether a maintenance event is triggered based on the usage data. A recommendation is made at the computing device to conduct a maintenance event based on the determination. The maintenance event can include battery replacement.

A computer implemented method for managing battery use of personal mobility carts in a fleet of personal mobility carts is provided. The method includes receiving, at a computing device having one or more processors, battery usage data from each personal mobility cart of the fleet of personal mobility carts. Battery charge and discharge cycles are assessed at the computing device of each personal mobility cart of the fleet of mobility carts. A score indicative of a battery handling is displayed at the computing device. A determination is made at the computing device whether the fleet is being handled unsatisfactorily based on the score. A recommendation is made at the computing device to perform a corrective action to the fleet of personal mobility carts based on the determination.

According to additional features, the corrective action comprises communicating a push notification to at least one cart of the fleet of carts that a charge is required.

### BRIEF DESCRIPTION OF THE DRAWINGS

The present disclosure will become more fully understood from the detailed description and the accompanying drawings, wherein:

FIG. 1 is a diagram of an exemplary personal mobility cart fleet management platform in accordance to the present disclosure;

FIG. 2 is a diagram of an example computing system including an example computing device and an example server computing device configured to implement the personal mobility cart fleet management platform of FIG. 1 according to some implementations of the present disclosure;

FIG. 3 is a functional block diagram of the example computing device of FIG. 2;

FIG. 4 is a functional block diagram of a mobility cart of FIG. 1 according to some implementations of the present disclosure;

FIG. 5 is a first example fleet management interface including a geofencing interface that assists a user in security management according to some implementations of the present disclosure;

FIG. 6 is a second example fleet management interface including a mobility cart usage interface that assists a user in usage management according to some implementations of the present disclosure;

FIG. 7 is a third example fleet management interface including a battery management interface that scores charging and discharging behaviors according to some implementations of the present disclosure;

FIG. 8 is an exemplary method of using the geofencing interface of FIG. 5;

FIG. 9 is an exemplary method of using the mobility cart usage interface of FIG. 6; and

FIG. 10 is an exemplary method of using the battery management interface of FIG. 7.

### DETAILED DESCRIPTION

As mentioned above, there is a need for improved systems and methods for monitoring real-time attributes of mobility carts in a fleet of mobility carts. As explained in detail herein, the monitoring can be done at the retail/store level, such as by a fleet manager at the store or corporation who may be in charge of running the fleet of mobility carts. Additionally or alternatively, the monitoring can be done at the manufacturer level, such as by the company who manufactures and/or provides the fleet of carts to the store for use. As used herein, mobility carts are defined as ride-on carts configured for a single rider for navigating a shopping store during shopping. The mobility carts are generally limited to slow speeds (e.g., less than 10 mph). In some, but not all implementations, the mobility carts can have a basket configured thereon for loading goods for purchase at the store and for transportation outside of the store (e.g., within a store parking lot). Mobility carts can also be defined as personal mobility arts in settings other than stores such as industrial carts, that in some examples do not have baskets, for navigating around industrial buildings within the scope of this disclosure.

Important attributes for monitoring on the mobility carts can include state of charge, charging status, daily run time, total run time and geographic location. The present disclosure is directed toward a personal mobility cart fleet management platform that collects and monitors, in real-time, various attributes of the mobility carts. These attributes can be reviewed and reacted to in real-time allowing the store (e.g. retailer) to better manage these assets. The data associated with the monitored attributes is used to identify key characteristics such as location of the mobility carts, assess cart utilization, and monitor components of the mobility carts such as battery status. The location of the mobility cart can be used to deter theft. Cart utilization can be used to identify stores having too many or too few carts in their fleet. With this information stores can react by altering the number of mobility carts available at a given location to better optimize the size of their fleet for a particular store to minimize cost. Locational placement of mobility carts within a store (e.g., north entrance of store versus south entrance of store) can also be optimized based on an analysis of the utilization. Battery status can be used to implement more effective charging strategies and maximize battery life. Other maintenance items (motor, tires, etc.) can be monitored and reacted to.

Many embodiments or aspects of the present disclosure described below can take the form of computer-executable or controller-executable instructions, including routines executed by a programmable computer or controller or electronic devices. Those skilled in the relevant art will appreciate that the disclosed techniques can be practiced on electronic or computer or controller systems other than those shown and described below. The techniques described herein can be embodied in a special-purpose electronic or computer or data processor that is specifically programmed, configured, or constructed to execute one or more of the computer-executable instructions described below. Accordingly, the terms “computer” and “controller” as generally used herein refer to any data processor and can include servers, distributed computing systems, cloud computing, Internet appliances, and handheld devices, including palm-top computers, wearable computers, cellular or mobile phones, multi-processor systems, processor-based or programmable consumer electronics, network computers, mini computers, and the like. Information handled by these computer systems and computers and controllers can be presented at any suitable display medium, including a liquid crystal display (LCD). Instructions for executing electronic, or computer, or controller-executable tasks can be stored in or on any suitable computer-readable medium, including hardware, firmware, or a combination of hardware and firmware. Instructions can be contained in any suitable memory device, including, for example, a flash drive, USB device, and/or other suitable mediums.

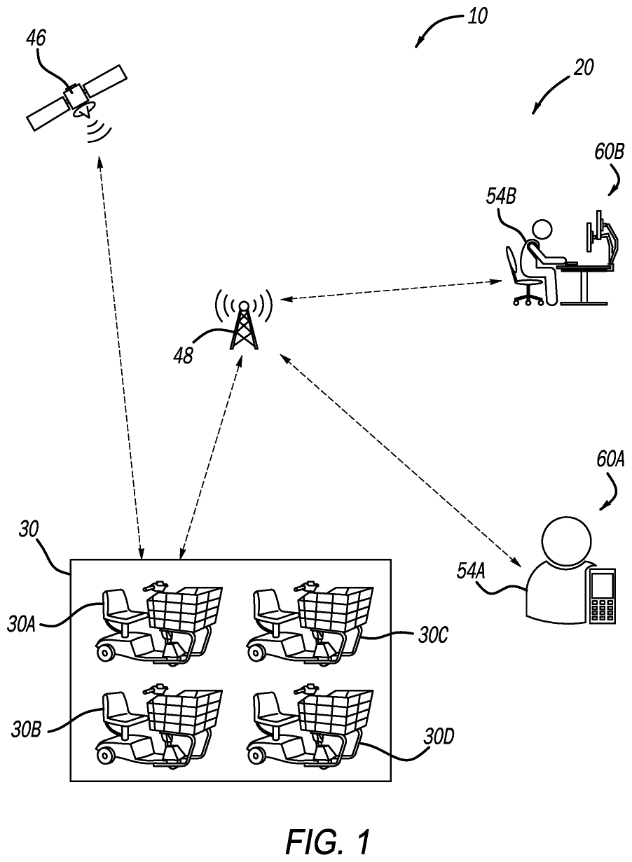

With initial reference to FIGS. 1-4, a mobility cart fleet management platform according to various examples of the present disclosure is shown and generally identified at reference numeral 10. The mobility cart fleet management platform 10 generally includes a computing system 20 having various computing devices 60 that are configured to communicate with a fleet of mobility carts, collectively identified at reference numeral 30, and individually identified at reference numerals 30A, 30B, 30C and 30D. It is appreciated that while the fleet 30 is represented as four mobility carts 30A, 30B, 30C and 30D, the fleet 30 can generally comprise any number of mobility carts.

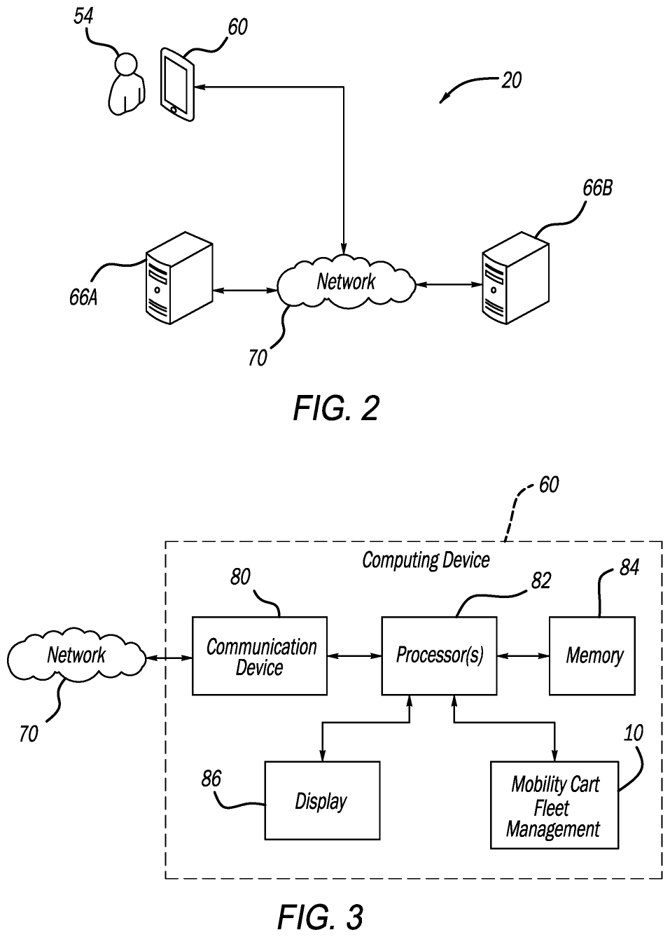

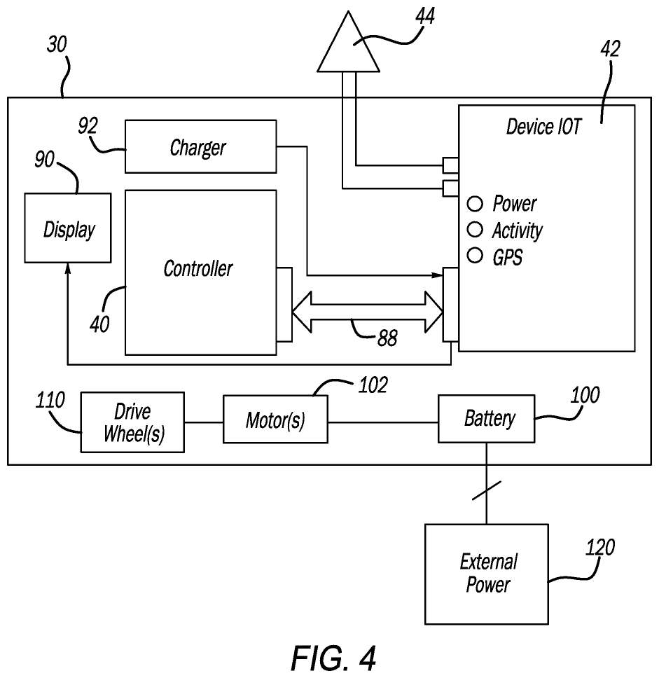

In examples, each mobility cart 30 includes a controller 40 (FIG. 4) that is electrically connected with a communication module 42 having an antenna 44 that wirelessly communicates between a satellite 46 (FIG. 1) and/or cellular tower 48. In one non-limiting example, the communication module 42 is a transceiver, although other forms of hardware are within the scope of the present disclosure. The communication module 42 can transmit and receive information between the satellite 46 and/or the cellular tower 48 indicative of a geospatial location of the mobility cart 30. As will become appreciated herein, the location information of each mobility cart 30 can be communicated, such as through a network 70 (FIG. 2), to computing devices 60A and 60B. Additionally, the communication module 42 can communicate additional attributes (usage information, component status, battery statistics, etc.) associated with the specific mobility cart 30. By way of example only it is contemplated that the user 54A can be a store level user such as a fleet manager tasked with running the fleet of mobility carts 30 at the store. The user 54B can be a user at the manufacturer level, such as at the company that provides the fleet of carts 30 to the store for use. Additional users may also be assigned or given access to the mobility cart fleet management platform 10.

Referring now to FIG. 2, a diagram of an example computing system 20 is illustrated. The computing system 20 can be configured to implement the mobility cart fleet management platform 10 described herein, e.g., amongst a plurality of users via their computing devices 60. The computing system 20 can include one or more example computing devices 60 and one or more example servers 66 that communicate via the network 70 according to some implementations of the present disclosure. For ease of description, in this application and as shown in FIG. 2, one example computing device 60 (shown as computing devices 60A and 60B, FIG. 1) and two example server computing devices 66A and 66B are illustrated and described. It should be appreciated, however, that there can be more computing devices 60 and more or less server computing devices 66 than is illustrated. While illustrated as a mobile phone (a “smart” phone) 60 in FIG. 2, each computing device 60 can be any type of suitable computing device, such as a desktop computer, a tablet computer, a laptop computer, a wearable computing device such as eyewear, a watch or other piece of jewelry, or clothing that incorporates a computing device.

A functional block diagram of an example computing device 60 is illustrated in FIG. 3. The computing device 60 is shown as including a communication device 80, one more processors 82, a memory 84, a display device 86, and the mobility cart fleet management platform 10. The processor(s) 82 can control the operation of the computing device 60, including implementing at least a portion of the techniques of the present disclosure. The term “processor” as used herein is intended to refer to both a single processor and multiple processors operating together, e.g., in a parallel or distributed architecture. In some implementations, the mobility cart fleet management platform 10 can be carried out through an application executed by the computing device.

The communication device 80 can be configured for communication with other devices (e.g., the server computing devices 66 or other computing devices 60) via the network 70. One non-limiting example of the communication device 80 is a transceiver, although other forms of hardware are within the scope of the present disclosure. The memory 84 can be any suitable storage medium (flash, hard disk, etc.) configured to store information. For example, the memory 84 may store a set of instructions that are executable by the processor 82, which causes the computing device 60 to perform operations (e.g., such as the operations of the present disclosure). The display device 86 can display information to the user 54. In some implementations, the display device 86 can comprise a touch-sensitive display device (such as a capacitive touchscreen and the like), although non-touch display devices are within the scope of the present disclosure.

It should be appreciated that the example server computing devices 66 can include the same or similar components as the computing device 60, and thus can be configured to perform some or all of the techniques of the present disclosure. Further, while the techniques of the present disclosure are described herein in the context of the mobility cart fleet management platform 10, which is illustrated as being a component of the computing device 60, it is specifically contemplated that each feature of the techniques may be performed by a single computing device 60 alone, a plurality of computing devices 60 operating together, a server computing device 66 alone, a plurality of server computing devices 66 operating together, and a combination of one or more computing devices 60 and one or more server computing devices 66 operating together.

With additional reference now to FIG. 4, a functional block diagram of an exemplary mobility cart 30 used in the mobility cart fleet management platform 10 will be described. While one mobility cart 30 is shown and described in FIG. 4, it is appreciated that each of the mobility carts (30A, 30B, 30C, 30D, etc.) of the fleet of mobility carts 30 can be constructed similarly. The mobility cart 30 includes the controller 40, the communication module 42, the antenna 44, a display 90, a charger 92, a battery 100, an electric motor 102 and drive wheels 110. The controller 40 is electrically connected, such as through a wire harness 88, to the communication module 42. The controller 40 can facilitate operation in various modes such as an indoor mode and an outdoor mode based on location information determined by and communicated through the communication module 42. The communication module 42 can wirelessly communicate (e.g., through the satellite 46 and/or the cellular tower 48) real-time information related to attributes of the mobility cart 30. Again, attributes can include location information, usage information, battery charge information and other operational attributes of components in the mobility cart 30. In examples, the information can be pushed to the network 70 and viewed by the computing devices 60A and 60B.

The display 90 provided on the mobility cart 30 can display operational information to a mobility cart rider. The operational information can include any status information related to the mobility cart 30 including, but not limited to, battery status, acceleration information, GPS information, drive mode, map information including relationship of the mobility cart 30 relative to a store, a charging location, and boundary locations assigned to the mobility cart 30 as described herein. The charger 92 can provide various signals related to a charging event or charge status of the mobility cart 30. The charger 92 (and/or the controller 40) can further be configured to provide a drive inhibit signal whereby the communication module 42 can communicate information indicative of an inoperable cart condition due to lack of charge. The communication device 42 communicates signals by way of the antenna 44. The battery 100 provides power to the electric motor (or motors) 102 that transmit drive torque to the drive wheels (or wheel) 110. The battery 100 is selectively connectable to external power (alternating current such as from a wall outlet) 120 for delivering current to the charger 92 for charging the battery 100.

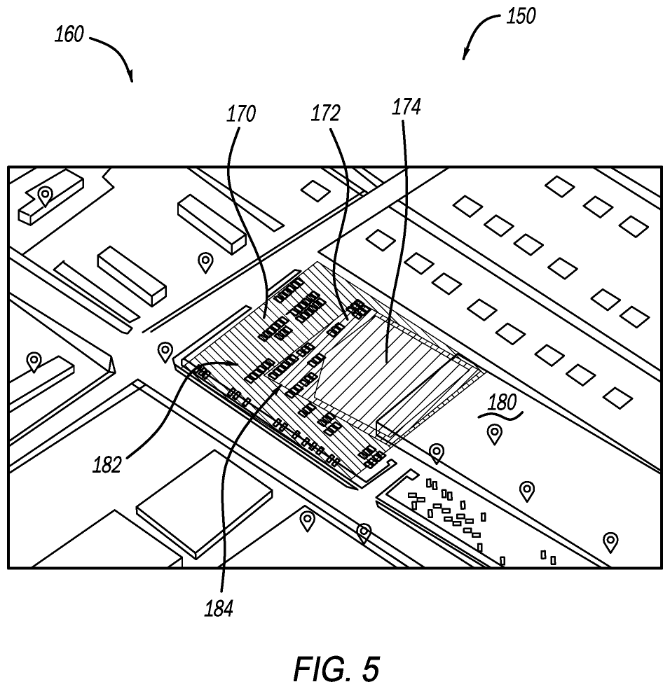

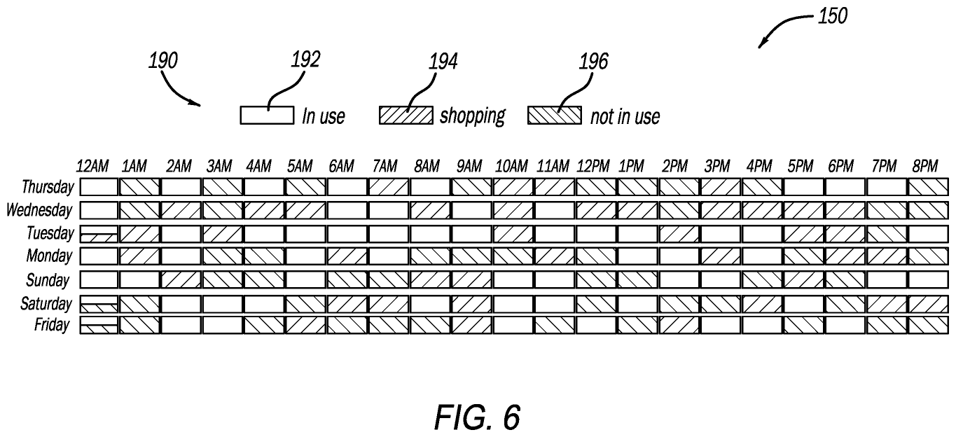

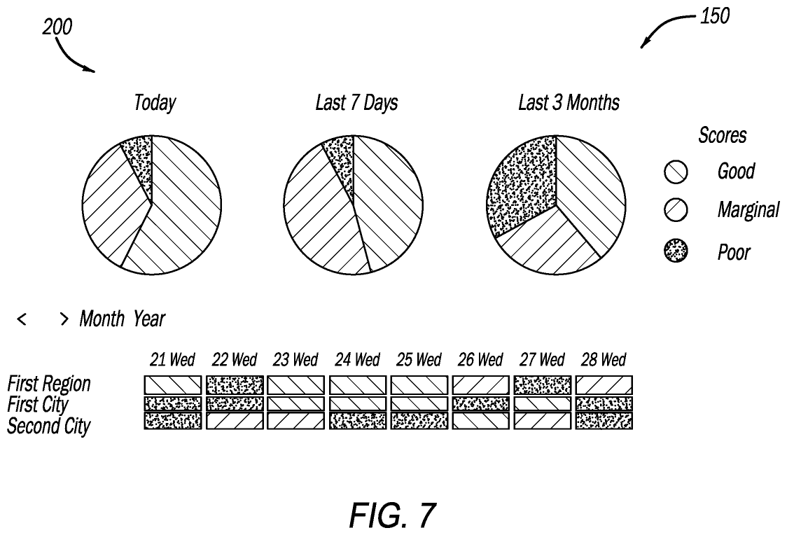

With additional reference now to FIGS. 5-7, example implementations of the mobility cart fleet management platform 10 will be described. The computing system 20 can be configured on the computing devices 60 as an interactive dashboard or fleet management interface 150. The interactive fleet management interface 150 can be a tactical and/or strategic tool which a store/retailer user (54A) and/or a cart manufacturer user (54B) can use to assess performance at any level of the fleet 30 including individual carts 30A, 30B, 30C, 30D, etc., individual stores, regions or corporations. The interactive fleet management interface 150 is described herein as various dashboards that display and receive information related to the fleet of carts 30 to the user 54A, 54B. The fleet management interface 150 explained sequentially below can include a geofencing interface (FIG. 5), a cart usage interface (FIG. 6) and a battery management interface (FIG. 7).

With reference to FIG. 5, the fleet management interface 150 can include a geofencing interface that assists the user 54A, 54B in security management. In examples, a user 54A, 54B can customize multiple geofence map boundaries 160 which can trigger remote control of cart drive capabilities to deter theft. In the example shown in FIG. 5, the geofence map boundaries 160 include a first zone 170, a second zone 172 and a third zone 174. Each zone 170, 172 and 174 represents a unique boundary that is customized by the user 54A, 54B. By way of example, the first zone 170 can establish a first boundary furthest from the store, the third zone 174 can establish a third boundary closest to the store 180, and the second zone 172 can establish a second boundary between the first and second zones 170, 174. Additional (or fewer) zones may be established by the user 54A, 54B as needed. The locations of the respective zones 170, 172 and 174 can be established (and optionally modified thereafter) by the user 54. As described above, each mobility cart 30 has a communication module 42 that provides location information of the mobility cart 30. The real-time location, such as which zone 170, 172 and 174 a mobility cart occupies, can be communicated to the computing system 20 and ultimately to the computing device 60 (and displayed on the display 86) such that the user 54 is informed of the real-time location of each mobility cart 30. In some examples, the display 90 in the mobility cart 30 can additionally convey the location of the cart being driven to the mobility cart rider.

Transitions between zones 170, 172, 174 can trigger a notification at the computing device 60. It is contemplated that various location status updates can be additionally communicated to the mobility cart rider, such as through the display 90, indicative of the occupied zone. A warning can be displayed to the rider such as when the mobility cart 30 is nearing or has passed beyond one of the boundaries such as the outer boundary of the first zone 170. In examples, the display 90 can convey a warning to the rider that the personal mobility cart 30 is in an unacceptable location based on the location being outside of the first zone 170. In examples, the warning can be triggered by the controller 40 on the cart 30, or be triggered by preset conditions at the computing device 60A, 60B used by the user 54A, 54B (e.g., through the network 70 and received by the communication module 42).

With reference to FIG. 6, the fleet management interface 150 can include a cart usage interface 190 that assists the user 54A, 54B in usage management. The fleet management interface 150 can allow the user 54A, 54B the ability to assess utilization (in the example shown, daily/weekly/monthly) of the carts 30. The cart usage interface 190 of FIG. 6 includes a usage chart categorized as “in use” 192, “shopping” 194 and “not in use” 196. It is contemplated that each cart of the fleet of carts 30 will have unique usage data. It is appreciated that the cart usage interface 190 shown in FIG. 6 can represent collective cart usage for a first fleet of carts at a first store. The cart usage interface 190 can be configured to display additional cart usage statistics for additional fleets at other locations for comparison. An analysis of the utilization can prompt the 54A, 54B to redeploy some of the carts 30 such as from a low use location to a high use location. It is contemplated that such analysis can be performed in many ways. For example, the analysis can be done manually by the user 54A, 54B, by programs (software, etc.) having predetermined thresholds that trigger action or by artificial intelligence techniques including machine learning, representation learning, similarity search and causal inference. In this regard, the fleet management interface 150 can be used to determine the most appropriate quantity of carts 30 needed for a particular store. In additional implementations, a determination can be made to populate more mobility carts at high traffic areas of a store, or populate more mobility carts during specific high use timeframes. Use of the carts 30 can be further tracked to highlight heavy use periods that may further drive network redeployment of the carts 30 to best accommodate various situations.

With reference to FIG. 7, the fleet management interface 150 can include a battery management interface 200 that scores charging and discharging behaviors of carts 30. In the example shown, the fleet of carts 30 is collectively scored in timeframes of “Today”, “Last 7 Days” and “Last 3 Months”. Scores of “Good”, “Marginal” and “Poor” are established based on charge/discharge thresholds set, such as by the equipment manufacturer (explained herein as user 54B). In other implementations, the battery management interface 200 can be configured to additionally display cart specific scores. The charging score can have a direct impact on longevity of the battery 100. In this regard it is desirable to perform corrective actions based on a score less than “Good” to optimize the life of the battery 100.

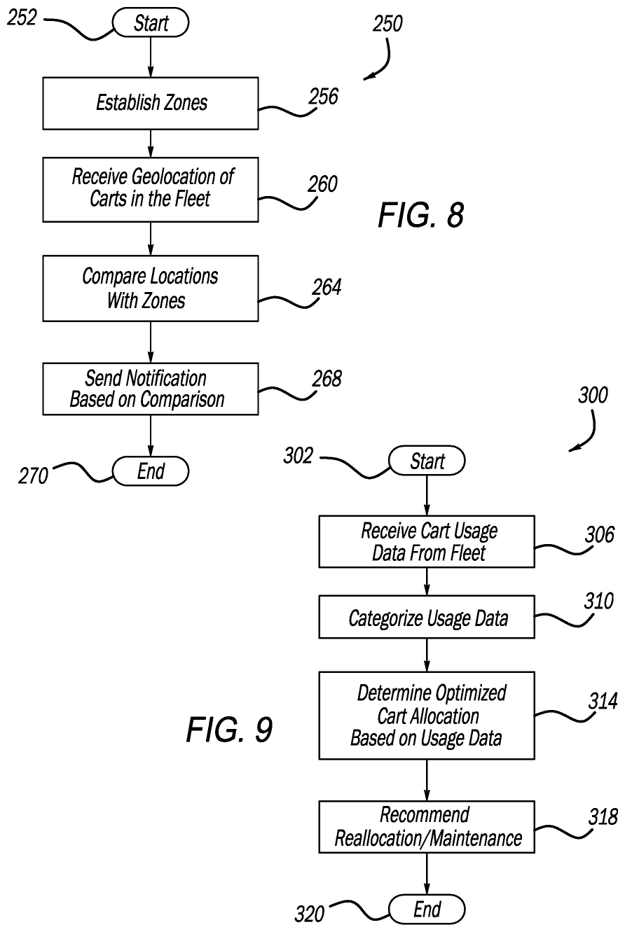

With particular reference now to FIGS. 5 and 8, an exemplary method of using the geofencing interface 160 will be described. The method of using the geofencing interface 160 is generally identified at reference 250. The method starts at 252. Zones (e.g., zones 170, 172, 174) are established by the user 54A, 54B. Again, the zones can be determined in any manner such as any combinations of within a store 180, near the store 180, and within a parking lot. In examples, the zones 170, 172 and 174 can be stored at the controller 40 and/or the communication module 42 of the cart 30. The boundaries for each zone can be updated at any time at the computing device 60A, 60B and communicated to the communication module 42 through the network 70.

In examples, the interface 150 can allow the user 54A, 54B to simply click and drag a perimeter line (such as perimeter line 184 of zone 172) of a zone to a desired boundary location. At 260 the geolocation of all the carts in the fleet of carts 30 is received. At 264, the locations of each of the carts 30 is compared with the established zones 170, 172, 174. At 268 a notification is communicated based on the comparison. A notification can include a push notification such as an alarm initiated at the computing device 60A, 60B (and conveyed on the display 86 visually and/or audibly) for consumption by the user 54A, 54B. Additionally or alternatively, a notification can include a push notification such as an alarm initiated at the display 90 on the cart 30 for consumption by the rider of the cart 30. Further, if it is determined that the cart 30 is outside of (or approaching) the first boundary 70, a signal can be communicated from the computing device 60A, 60B to display a message (“return cart to store”, “approaching store boundary”, etc.) indicative of a current location or an approaching location of the mobility cart 30. An additional signal can be communicated that disables powered operation of the cart 30. In additional examples, the controller 40 of the cart 30 can initiate disabling powered operation of the cart 30 based on a determination that the cart 30 is outside of a particular zone. The method ends at 270.

With particular reference now to FIGS. 6 and 9, an exemplary method of using the mobility cart usage interface 190 will be described. The method of using the mobility cart usage interface 190 is generally identified at reference 300. In examples, the method 300 can be used to allocate fleets of personal mobility carts between stores to best locate carts where they are needed most. The method starts at 302. At 306, cart usage data is received from all carts 30A, 30B, 30C, 30D of the fleet of carts 30. In examples, cart data can be received by a first fleet of carts at a first location (e.g., a first store) and a second fleet of carts at a second location (e.g., a second store). At 310 the usage data is categorized. In some examples, usage of the carts can be sensed based on the controller 40 providing a drive status to the communication module 42. The categorization can be include summaries of typical paths traversed by each cart 30. The drive status can be triggered by one or more switches in the cart 30 (e.g., a seat switch, a key switch etc.). The drive status can be communicated in real-time by the communication module 42 to the computing device 60A, 60B through the network 70.

At 314, an optimized cart allocation is determined based on the usage data. At 318, a recommended reallocation or maintenance action is recommended. A reallocation can be recommended based on comparing usage of the first fleet compared to usage of the second fleet. A determination can be made based on the comparing whether one of the first or second fleet of mobility carts is overutilized compared to the other fleet. A recommendation can be made to move one or more mobility carts from an underutilized store to the overutilized store.

It is contemplated that a maintenance event can be triggered based on an analysis of usage data. For example, a component (motor, battery, tires, etc.) may have an effective use life whereby a threshold can be set by the user 54A, 54B such that a usage summary exceeding a threshold can trigger a component maintenance event (replacement, etc.). In additional examples, the communication module 42 can read and communicate any fault codes set by the controller 40 to the computing device 60A, 60B through the network 70. The method ends at 320.

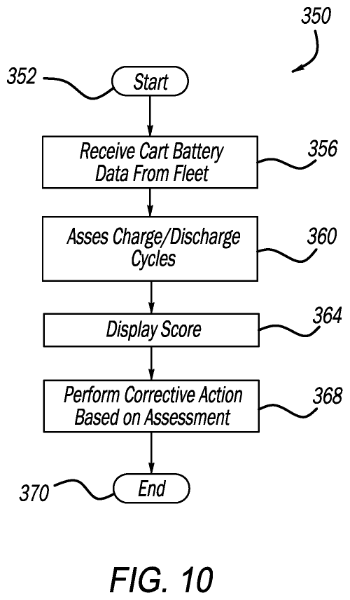

With particular reference now to FIGS. 7 and 10, an exemplary method of using the battery management interface 200 will be described. The method of using the battery management interface 200 is generally identified at reference 350. The method starts at 352. At 356, cart battery data is received from all carts 30 of the fleet of carts. At 360, the charge/discharge cycles are assessed. At 364 a score is displayed based on the assessment. The scores can be tallied individually for each cart or collectively as a fleet score. At 368 a corrective action is recommended to be performed based on the assessment.

As with other techniques described herein, the scores and recommended corrective action can be carried out in many ways. For example, the analysis can be done manually by the user 54A, 54B, by programs (software, etc.) having predetermined thresholds that trigger action or by artificial intelligence techniques including machine learning, representation learning, similarity search and causal inference. In examples, the corrective action can include communicating a push notification to the user 54A, 54B at the computing device 54A, 54B indicative that a charge of the battery 100 is needed (e.g., soon, immediately, or after some time based on charge status compared to a predetermined low battery threshold). In additional examples, the battery management interface 200 can additionally track the health of other components of the carts 30. For example, characteristics of the motor(s) 102 (amperage, etc.) can be determined by the controller 40 and communicated to the network 70 through the communication module 42 for accessing at the computing device 60A, 60B. In this regard, an overloading or other failure of the motor 102 (or other component of the mobility cart 30) can be communicated to the computing device 60A, 60B for triggering a remedial action. The method ends at 370.

Detailed embodiments of the present disclosure are disclosed herein; however, it is to be understood that the disclosed embodiments are merely exemplary of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entirety to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other types of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, Internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server. In embodiments, the server may be a virtual machine that is executed by a processing system of a cloud-services platform (e.g., Amazon AWS). In these embodiments, the cloud-services platform may offer computing resources that host and support various aspects of a third-party's software systems.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, Internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, and instructions described herein and elsewhere may be executed by one or more of the network infrastructural elements. The methods and systems described herein may be adapted for use with any kind of private, community, or hybrid cloud computing network or cloud computing environment, including those that involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flowcharts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flowchart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium. The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

The use of the terms “a” and “an” and “the” and similar referents in the context of describing the disclosure (especially in the context of the following claims) is to be construed to cover both the singular and the plural unless otherwise indicated herein or clearly contradicted by context. The terms “comprising,” “having,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

Any element in a claim that does not explicitly state “means for” performing a specified function, or “step for” performing a specified function, is not to be interpreted as a “means” or “step” clause as specified in 35 U.S.C. § 112(f). In particular, any use of “step of” in the claims is not intended to invoke the provision of 35 U.S.C. § 112(f).

Persons skilled in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer implemented method for determining locations of personal mobility carts in a fleet of personal mobility carts, the method comprising:
establishing, at a computing device having one or more processors, at least a first zone having a first perimeter boundary;
receiving, at the computing device, geolocations of each personal mobility cart in the fleet of personal mobility carts;
comparing, by the computing device, the geolocations of each personal mobility cart of the fleet of personal mobility carts with the first zone;
determining, by the computing device, whether a personal mobility cart of the fleet of personal mobility carts occupies a location outside of the first zone; and
generating, by the computing device, a notification based on the determination.

2. The method of claim 1, further comprising:
establishing, at the computing device, a second zone having a second perimeter boundary, the second zone having a different perimeter as compared to the first zone;
determining, by the computing device, whether a personal mobility cart of the fleet of personal mobility carts transitions between the first zone and the second zone; and
wherein generating the notification comprises identifying on the computing device the transition.

3. The method of claim 2, further comprising:
displaying, in real-time, geolocations of each personal mobility cart in the fleet of personal mobility carts on a display of the computing device.

4. The method of claim 1 wherein generating the notification comprises:
generating, at the computing device, a push notification including an alarm indicative of the personal mobility cart occupying a geolocation outside of the first zone.

5. The method of claim 4, further comprising:
communicating a signal to the personal mobility cart indicative of an unacceptable location of the personal mobility cart based on a determination that the geolocation of the personal mobility cart is outside of the first zone.

6. The method of claim 5 wherein the signal includes at least one of a visual and audible alarm.

7. A computer implemented method for allocating fleets of personal mobility carts between a first store and a second store, the method comprising:
receiving, at a computing device having one or more processors, usage data from each personal mobility cart of a first fleet of personal mobility carts at a first store and each personal mobility cart of a second fleet of personal mobility carts at a second store;
categorizing, at the computing device, first usage data representative of the first fleet and second usage data representative of the second fleet;
comparing, at the computing device, the first usage data and the second usage data;
determining, at the computing device, based on the comparing whether one of the first and second fleet is overutilized as compared to the other of the first and second fleet; and
recommending, at the computing device, a reallocation of at least one personal mobility cart from the other of the first and second fleet to the overutilized fleet.

8. The method of claim 7 wherein the first usage data of the first fleet includes at least one of daily usage data and hourly usage data for the first store.

9. The method of claim 8 wherein the second usage data of the second fleet includes at least one of daily usage data and hourly usage data for the second store.

10. The method of claim 7, further comprising:
determining, at the computing device, whether a maintenance event is triggered based on the usage data;
recommending, at the computing device, the maintenance event based on the determination.

11. The method of claim 10 wherein the maintenance event includes a battery replacement.

12. A computer implemented method for managing battery use of personal mobility carts in a fleet of personal mobility carts, the method comprising:
receiving, at a computing device having one or more processors, battery usage data from each personal mobility cart of the fleet of personal mobility carts;
assessing, at the computing device, battery charge and discharge cycles of each personal mobility cart of the fleet of personal mobility carts;
displaying, at the computing device, a score indicative of a battery handling of at least one personal mobility cart of the fleet;
determining, at the computing device, whether the at least one personal mobility cart of the fleet is being handled unsatisfactorily based on the score; and
recommending, at the computing device, a corrective action to the at least one personal mobility cart of the fleet of personal mobility carts based on the determination.

13. The method of claim 12 wherein the corrective action comprises communicating a push notification to at least one cart of the fleet of carts that a charge is required.

14. The method of claim 12, further comprising:
categorizing collectively battery charge and discharge cycles of all personal mobility carts of the fleet.

15. The method of claim 12 wherein recommending a corrective action comprises identifying an improved charge and discharge cycle.
